(19) United States
(12) Patent Application Publication
(10) Pub. No.: US 2004/0220690 A1
(43) Pub. Date: Nov. 4, 2004

(54) Method and apparatus for creating textured handle packaging

(75) Inventors: Seungyeol Hong, Plainfield, IL (US); Sheldon Yourist, York, PA (US)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA

(21) Appl. No.: 10/428,035

(22) Filed: May 2, 2003

(51) Int. Cl. G06F 19/00; B29C 33/40; G06K 9/36; G09G 5/00

(52) U.S. Cl. 700/98; 264/219; 382/285; 345/419; 345/582; 700/197

(57) ABSTRACT

A system, method, and computer program product in a computer system for generating an image for producing a design for a container, the method comprising the steps of generating a virtual sculptural relief design; projecting the virtual sculptural relief onto a virtual container surface, said virtual container surface corresponding to a non-open region of said container; manipulating said relief in three-dimensional space to provide a virtual projected sculptural relief on said non-open region of said virtual container surface; and removing the virtual conatiner surface outside the profile of the virtual projected sculptural relief. The container comprises a handle and a sidewall, a three-dimensional image being applied on the handle and sidewall of the container, the handle creating a hole between itself and the sidewall of the container. The image may be manipulated to fit multiple surfaces of the container which are at various angles with respect to one another.

### BACKGROUND OF THE INVENTION

1. Field of the Invention

The present invention relates to a method for designing a container, specifically a container comprising a handle and a sidewall, and more specifically to a container having a three-dimensional image, the image of a fruit tree leaf, for example, applied on the handle and sidewall of the container, the handle creating a hole between itself and the sidewall of the container.

2. Description of the Related Art

Blow-molded plastic containers have become commonplace in packaging products using hot-fill and cold-fill processes such as beverages including juice, for example. Such a container normally has a dome, an annular sidewall extending from a base, and a waist connecting the dome to the sidewall. Typically, the containers have a horizontal cross section which is circular, rectangular or multi-faceted. Blow-molded plastic containers can provide a package with sufficient flexure to compensate for pressure and temperature, while maintaining structural integrity and aesthetic appearance. In addition, the plastic used in the containers is recyclable. In order to increase the sales of beverages or other products, there is a need to produce aesthetically appealing containers.

Other containers, particularly those designed for larger volumes of liquids, can have a more rectangular cross-section. Such containers frequently have a handle molded into the container to make it easier to lift and to pour the contents from the container. These containers are also generally blow-molded by, for example, stretch blow-molding, extrusion blow-molding, and injection blow-molding. It is often desirable to place designs or a relief on a container for either functional reasons, such as to improve gripability, or ornamental reasons, for example by placement of a logo or some other means that promotes “brand identity.”

Making molds that create relief structures on containers is known. However, prior art mold-making methods are limited by how the designs are created and the intricacies of the mold-making process. Generally, these prior art methods have limited the scope of designs that can be created and the placement of designs. As a result of these limitations, designs are generally placed in relatively open spaces on a container. These open spaces can be, for example, on the dome of a round container or a flat surface of a rectangular container.

An example of a typical prior art method is a means for making a mold to create a sculpture to appear on a container. As shown in FIG. 1, a design is placed on an electrode attached to a rod. The electrode 1, heated with an electric current, is applied to a mold to leave a negative relief impression of the design on the mold. Thereafter, the mold is assembled to form a mold cavity. This method is useful for placing designs on a container dome or flat, open surface of a rectangular container. One drawback of this technique is that it can result in formation of a defective sculpture by misapplication of the electrode 1 to the mold. For example, the electrode 1 may be impressed too far against the mold leaving unwanted marks on the mold, which appear on the container, or the electrode 1 may not be pressed far enough against the mold leaving a poor impression of the design on the container. As the number of desired sculptures on a container increases, the number of possible sculptural defects increases. Since both defects occur due to variances in machine tolerances during the process of impressing the prior art electrode onto the mold, there is a need for a new method for creating sculptures on containers efficiently, quickly, repeatedly, at a low cost, and with a minimum of defects.

### BRIEF SUMMARY OF THE INVENTION

The above-mentioned disadvantages are overcome by a method in a computer system for generating an image for producing an electrode as disclosed in co-pending U.S. Patent Application No. 60/384,166 to Yourist filed May 31, 2002, which is incorporated herein by reference in its entirety. As disclosed therein, such a method may comprise the steps of generating a virtual sculptural relief; projecting the virtual sculptural relief onto a virtual mold cavity surface to form a virtual sculptural relief on the virtual mold cavity surface, the projected virtual sculptural relief having a profile; removing the virtual mold cavity surface outside the profile of the virtual projected sculptural relief; extending the virtual projected sculptural relief profile to a predetermined plane to form a virtual extension of the virtual projected sculptural relief, and combining the virtual projected sculptural relief with the virtual extension, which together form a virtual image of the electrode. The virtual image is converted into a numerical control language and a material is machined, based on the numerical control language, to form an electrode. The electrode is then used to impress a mold. While such a method is useful and precise, it is still limited to placing designs on open portions of the mold.

While the above-mentioned co-pending U.S. Patent Application overcomes several of the disadvantages discussed above, the method disclosed therein does not attempt to meet the challenge of applying a three-dimensional textured image to more intricate non-open areas of a container, for example the handle and sidewall, particularly when the handle forms a hole between itself and the sidewall of the container. Therefore, among other advantages, such a method would provide a container with a better grip for the user as well as enhancing the appearance of the container compared to conventional containers. It would be aesthetically and ergonomically advantageous if there existed a method and a device for applying a three-dimensional textured image to less open areas. A particular area would be, for example, the handle and sidewall of a container when the handle forms a hole between itself and the sidewall of the container. Challenges arise in such situations because the handle and sidwall of the container are offset angularly with respect to one another, thereby making the application of a textured image extremely time-consuming, expensive, and inefficient using existing techniques. What is needed, therefore, is a method and a device for applying a three-dimensional textured image to more than one surface of a container when the surfaces are angularly offset from one another.

An exemplary embodiment of the present invention provides the above-mentioned and other advantages through the provision of a method and device for providing a container comprising a handle and a sidewall, a three-dimensional sculptural image being applied on the handle and sidewall. The container may be a beverage container, for example, and the three-dimensional image may be in the form of a leaf of a fruit tree, for example. The handle may form a hole between itself and the sidewall of the container. According to the present invention, the above-mentioned advantages are met through the provision of a method for designing a three-dimensional textured image for being applied to more than one surface of a container when the surfaces are angularly offset from one another. The image may be projected onto the handle at an oblique angle. The angle at which the image is applied may be such that the image is applied to multiple surfaces of the handle and the sidewall of the container simultaneously.

The image to be manipulated and applied may be generated in a method similar to that described in U.S. Patent Application No. 60/384,166.

### BRIEF DESCRIPTION OF THE DRAWINGS

FIG. 1 shows a rod attached to an electrode created in accordance with the prior art;

FIG. 2a shows an exemplary non-round container;

FIG. 2b shows an exemplary cylindrical container;

FIG. 3 is an example of a workstation utilized to implement the present invention;

FIG. 4 is a flow chart showing a method of the present invention according to an exemplary embodiment thereof;

FIG. 5 is an exemplary two-dimensional, flat image to appear on the container;

FIGS. 6-9 are exemplary three-dimensional sculptural reliefs formed from the two-dimensional, flat image shown in FIG. 5;

FIGS. 10-14 illustrate the sculptural image of FIGS. 6-9 projected onto a container and being manipulated to fit the container surface;

FIGS. 15-17 show the simulated mold cavity surface outside boundary of the projected sculptural relief being trimmed away; and

FIG. 18 shows a container comprising a handle and a sidewall having a three-dimensional textured image applied thereon according to an exemplary embodiment of the present invention.

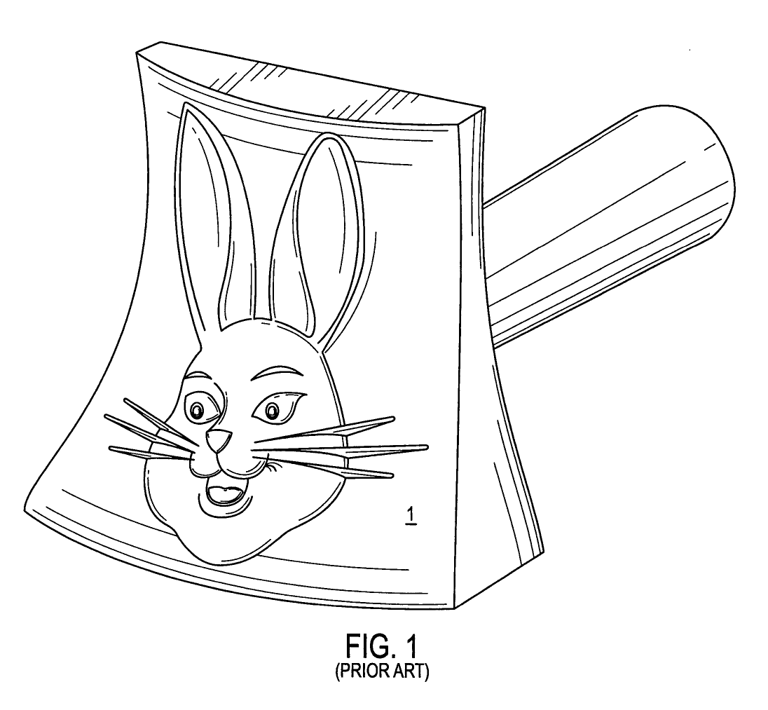

### DETAILED DESCRIPTION OF THE INVENTION

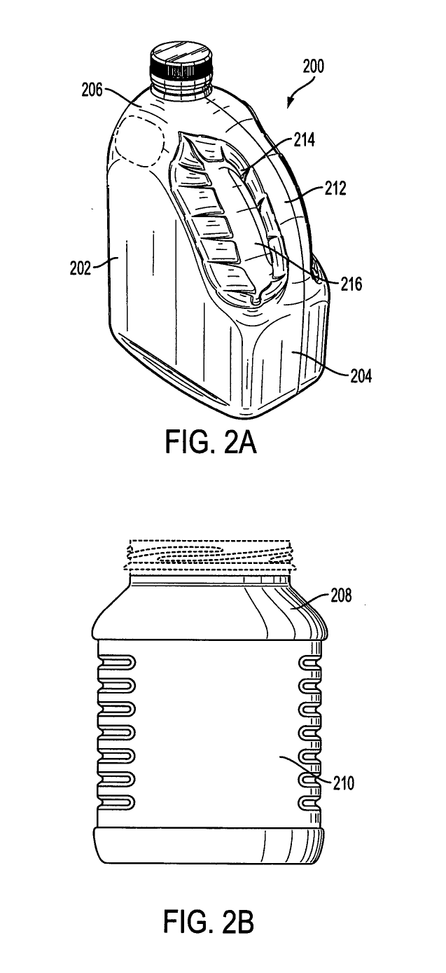

A computer system can be used to design a relief, a container, or place a relief design on a container. In a typical use of such systems, a design is placed on a container in an open region of the container. FIG. 2a shows an exemplary non-round container 200. Open areas in such a container include the relatively open sidewall 202, endwall 204, and dome 206 regions. In a cylindrical container, as shown in FIG. 2b, open areas include the dome 208 and sidewall 210 regions. Designing a container with a relief in non-open regions of the container is more difficult than placing a relief on an open region. As used herein, non-open regions are those that have multiple surfaces meeting at a variety of angles. With reference to FIG. 2a, non-open regions include, for example, the handle 212, interior handle surface 214, and the container wall underlying the handle 216.

Forming a continuous design on such a surface using prior art techniques is difficult. Preparing a mold for such a container using prior art techniques would require burning the design into a mold using multiple electrodes that approach at multiple angles including, for example, an oblique angle (i.e., an angle other than a right angle). Aligning such multiple electrodes to prepare a continuous design using such conventional techniques is a tedious and time-consuming task. For example, failure to properly align the electrodes would result in unacceptable design incontinuities. Alternatively, such molds could be hand-tooled. This, however, adds undesirable time and expense to the mold-making process. The present invention uses design software and automated tooling software to (a) generate a design, and (b) make a mold from the design.

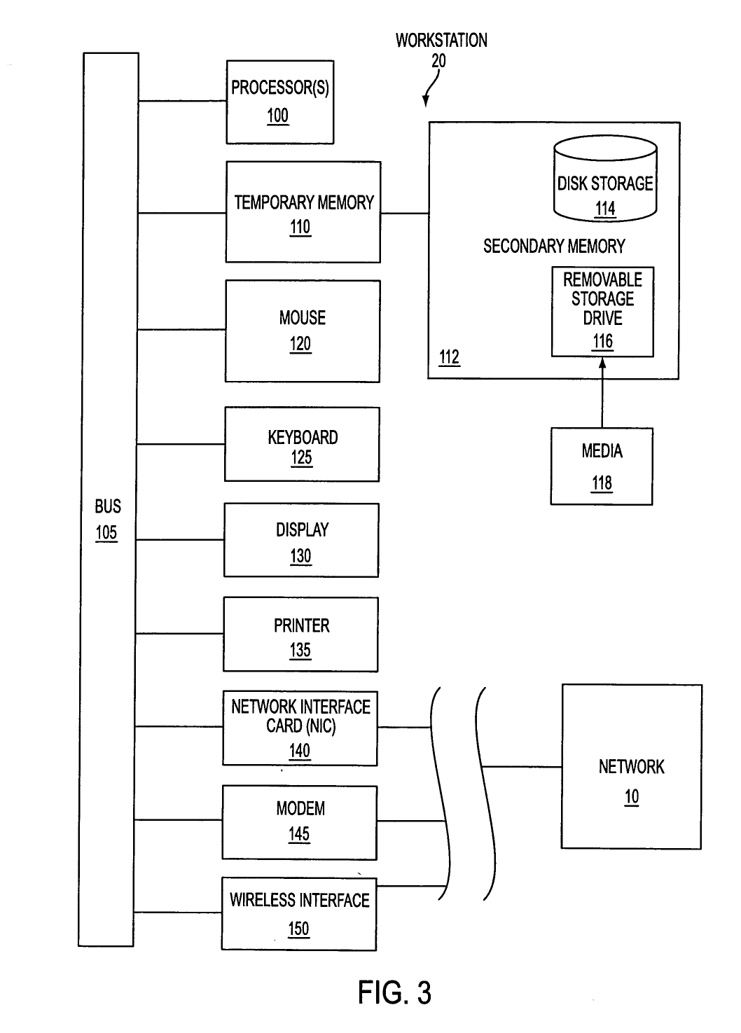

FIG. 3 shows a block diagram of a workstation 20 coupled to a network 10, which provides an example of a computer system, that may be used to implement the invention. The network 10 and the components interfacing with the network are optional parts of the computer system. Workstation 20 includes one or more processors 100 coupled to a bus 105. The bus 105 can be coupled to any of various subsystems including, for example: a temporary memory 110; a secondary memory 112 such as, a disk 114, and/or a removable storage drive 116 into which media 118 can be placed including, e.g., a diskette, a compact diskette (e.g. CD ROM) or the like; an input device such as a mouse 120, or a keyboard 125;

an output device such as a display 130 or printer 135; and input/output (I/O) devices to a network 10, for example an network interface card (NIC) 140, such as an Ethernet, Token Ring, Smart or Asynchronous Transfer Mode (ATM) card. Other input/output devices may include a modem 145, or other input/output device such as, a wireless interface 150 (e.g. a wireless transceiver). It will be apparent to those skilled in the relevant art that the above-described workstation 20 has been provided as an example and is not intended to limit the breadth of the invention in any way. The software performing the method steps may be stored on any storage medium, which can be accessed by the workstation 20.

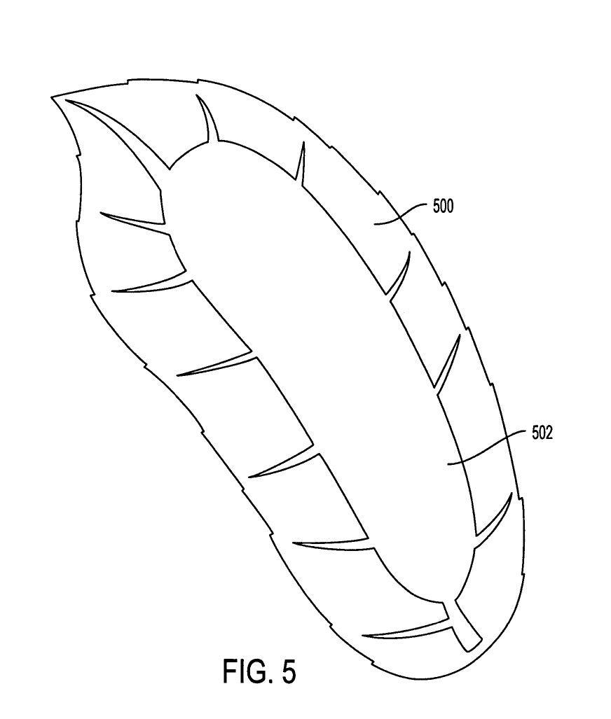

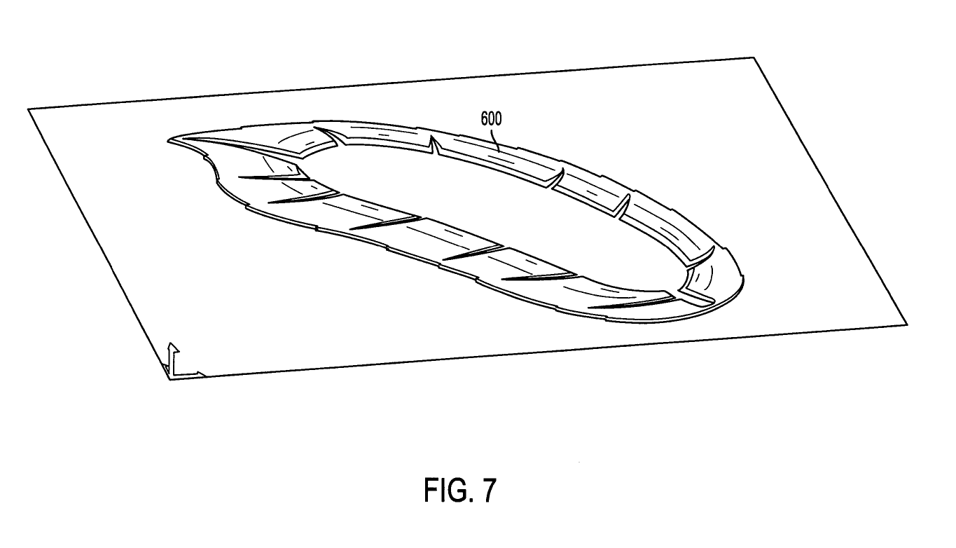

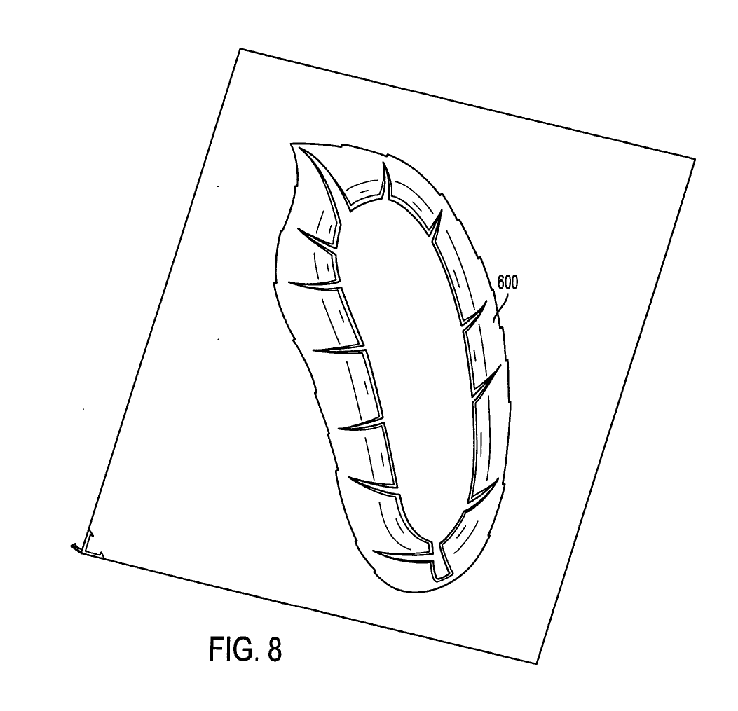

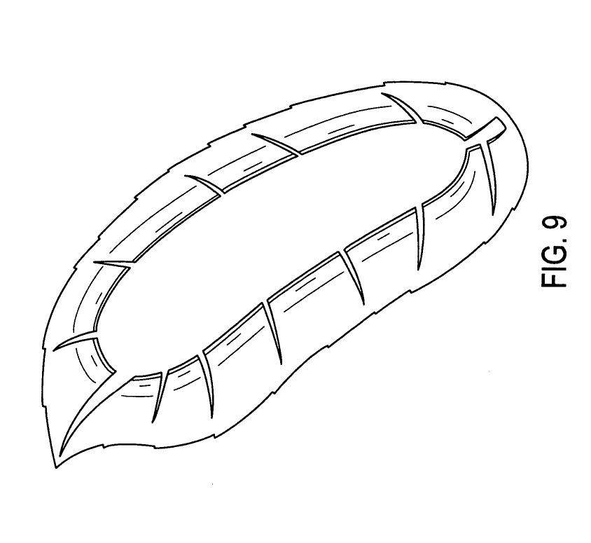

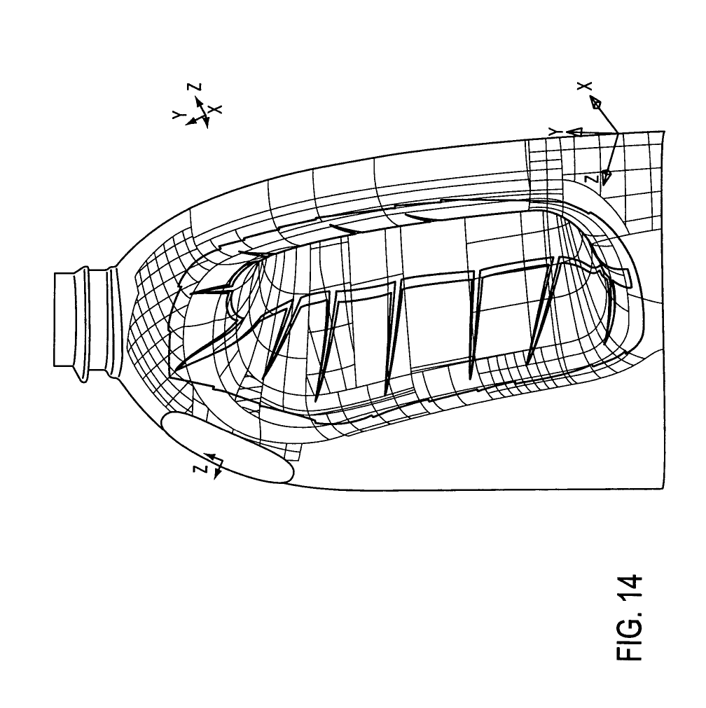

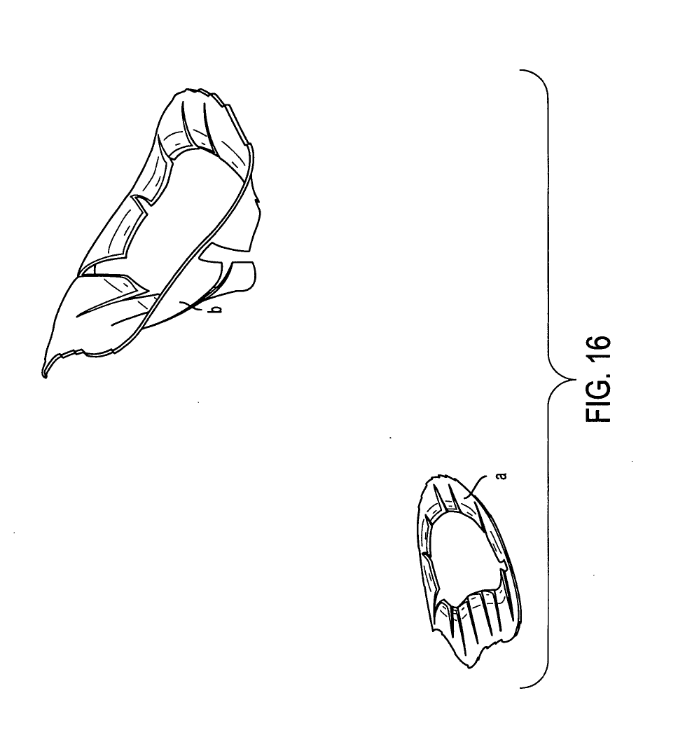

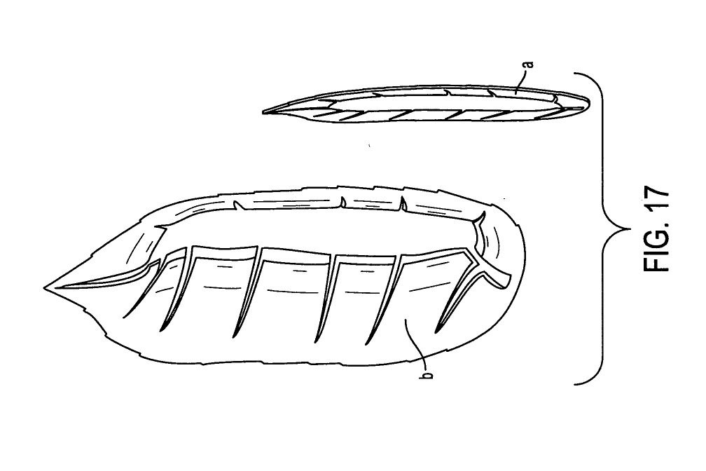

Although it is preferable that all of the images shown in FIGS. 5-17 be displayed on the display 130, it is understood that displaying each and every step is not necessary. It is further understood that the sculpture shown in the figures is only intended as an example. The designer may design any sculpture. Moreover, the designed electrode may be applied to any mold for any mold process. A dome shaped mold used in a blow-molding process is just one embodiment.

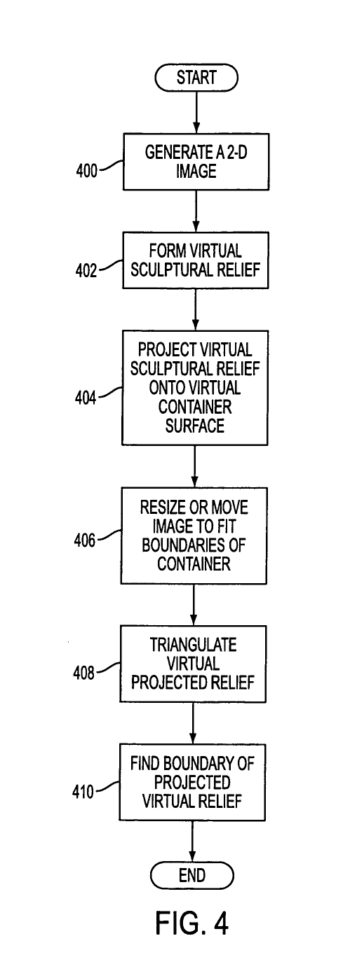

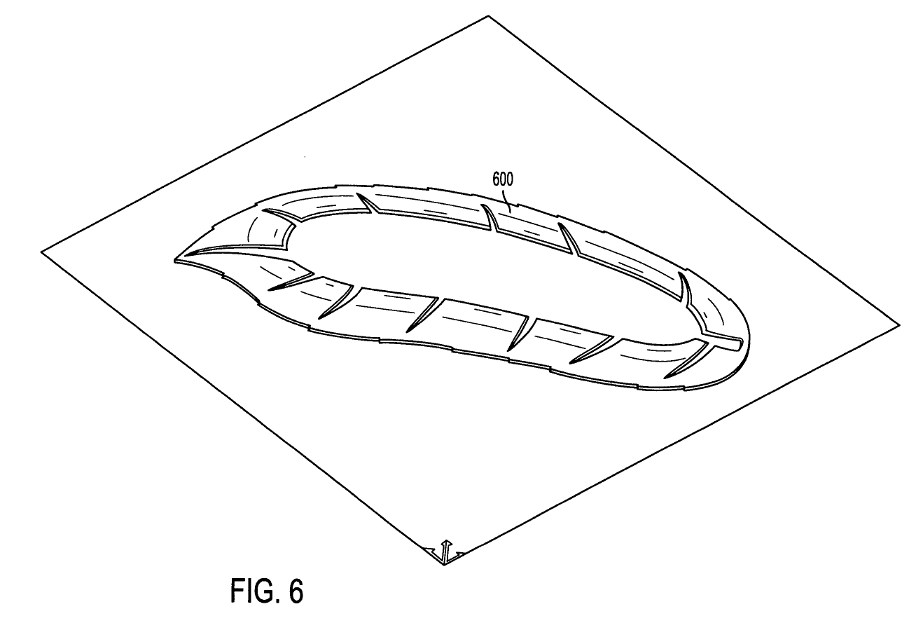

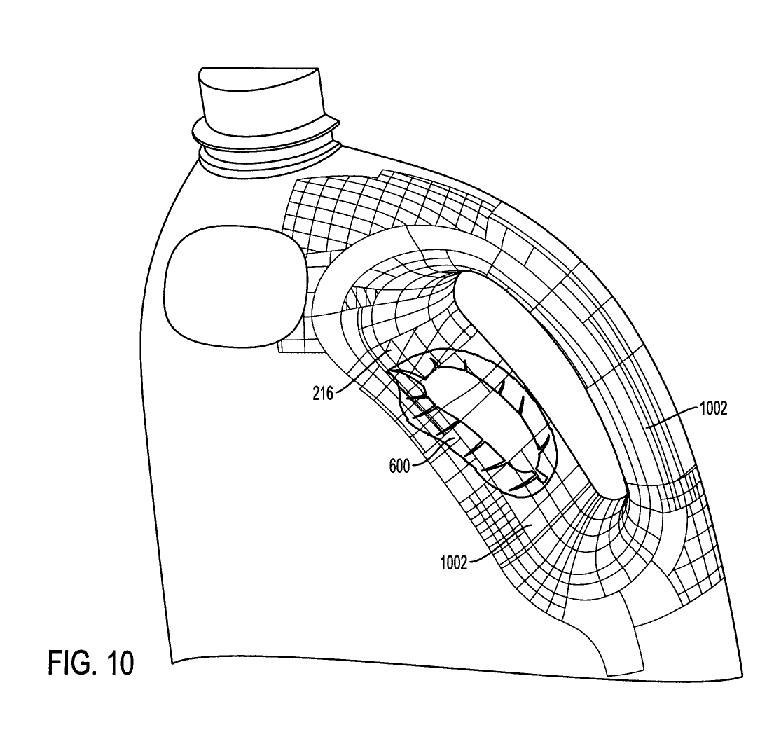

FIG. 4 is a flow chart showing an exemplary embodiment of the present invention. Exemplary illustrations of the method steps in the flow chart of FIG. 4 are shown in FIGS. 5-17. A designer may begin forming the design by generating a two-dimensional, flat image or shape of the artwork, which he or she wishes to appear on the container (step 400). An exemplary view of such an image is shown in FIG. 5. As illustrated in FIG. 5, the exemplary two-dimensional image 500 may be created with a hole 502 corresponding to the space between the handle 212 and the sidewall 202 of the container 200 to which the design is to be applied. Any other desired features or irregularities can be similarly incorporated into the desired design. In a step for forming a sculptural relief image (step 402), as seen in the exemplary illustration of FIGS. 6-9, the two-dimensional flat image 500 is transformed into a two-dimensional relief image 600. As shown in FIGS. 6-9, three-dimensional relief image 600 maintains hole 502 of two-dimensional image 500. The relief image 600 is designed in three dimensions with a particular relief geometry in mind in order to be compatible with the angular aspects of the container. Compare FIGS. 5-6. However, until the image is projected onto a container and suitably manipulated, it can not be used to create a mold. As shown in FIGS. 10-14, relief image 600 may be manipulated by, for example, rotating, stretching, or bending the relief image to a position suitable for projecting onto a virtual container.

Steps 400 and 402 may be implemented using commercial software packages such as, for example, ArtCam sold by Delcam plc of Birmingham, England. A sculptural relief is a three-dimensional image formed in an otherwise planar surface. A sculptural relief may be either positive (protruding from the plane toward an observer) or negative (receding from the plane relative to the observer). FIGS. 6-9 are examples of a positive sculptural relief image 600 formed from a two-dimensional, flat image 500 such as the one shown in FIG. 5, for example. Alternatively, sculptural relief image 600 may be created without referencing a two-dimensional image (step 402). Sculptural relief image 600 is stored in memory as digital data. Sculptural relief image 600 may be stored in a digital file format familiar to a tooling shop such as IGES or STL formats, for example.

After the sculptural relief image 600 is formed (step 402), the sculptural relief image 600 is projected onto a simulated or “virtual” container surface 1002 (step 404), as shown in FIG. 10. For the purposes of this description, simulated container surface means a virtual surface created on the display of the workstation which has a shape corresponding to the shape of the container surface on which the sculptural relief image 600 is to appear. FIGS. 10-14 show the sculptural relief image projected onto such a virtual surface 1002. The simulated container surface is not limited to being a container handle, but might extend to any scenario involving multiple surfaces with varying angular aspects relative to each other. Thus, the simulated container surface may be any shape onto which incorporation of a particular sculptural relief is desired.

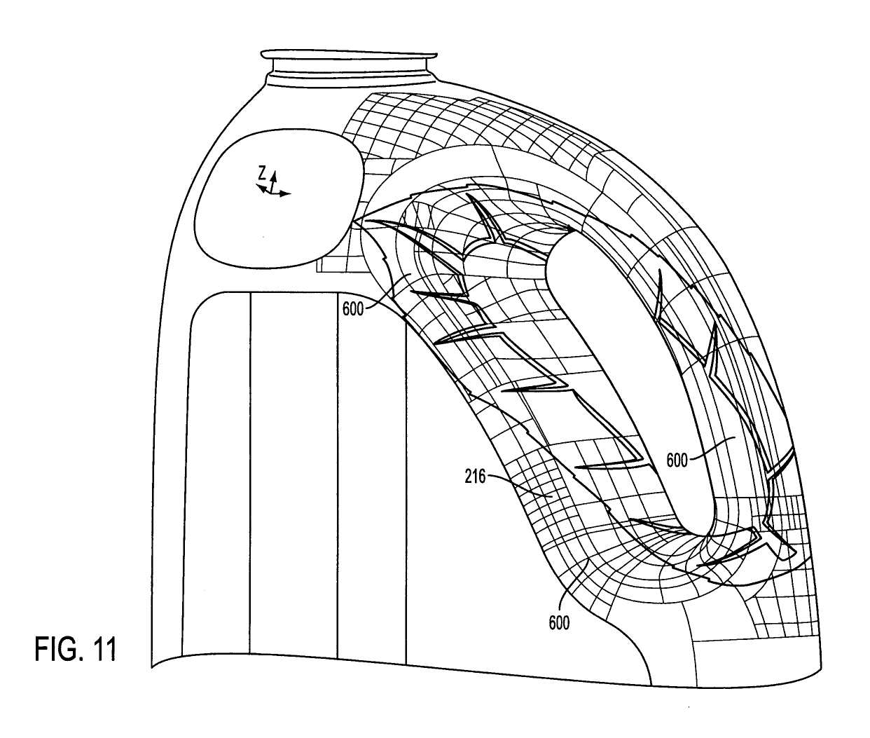

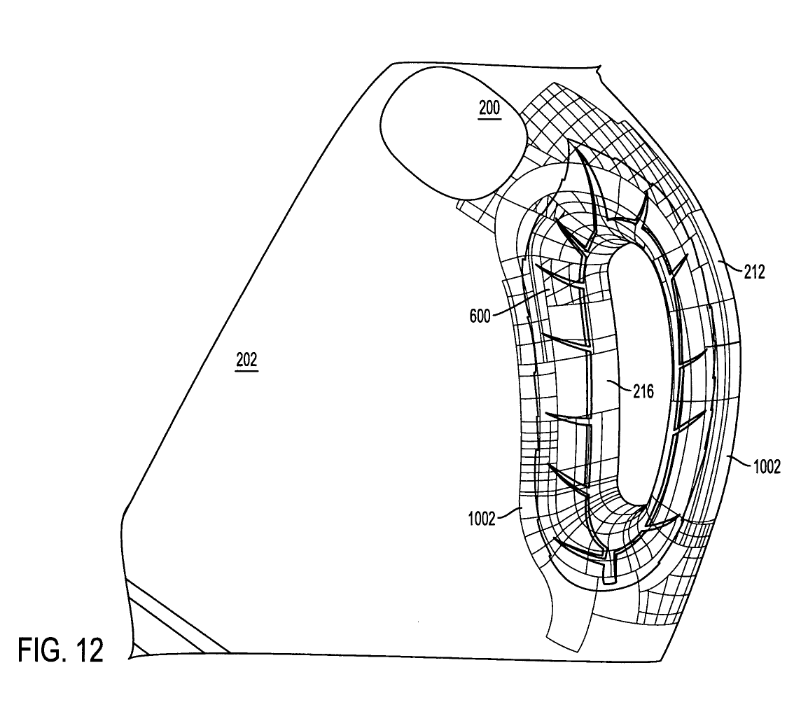

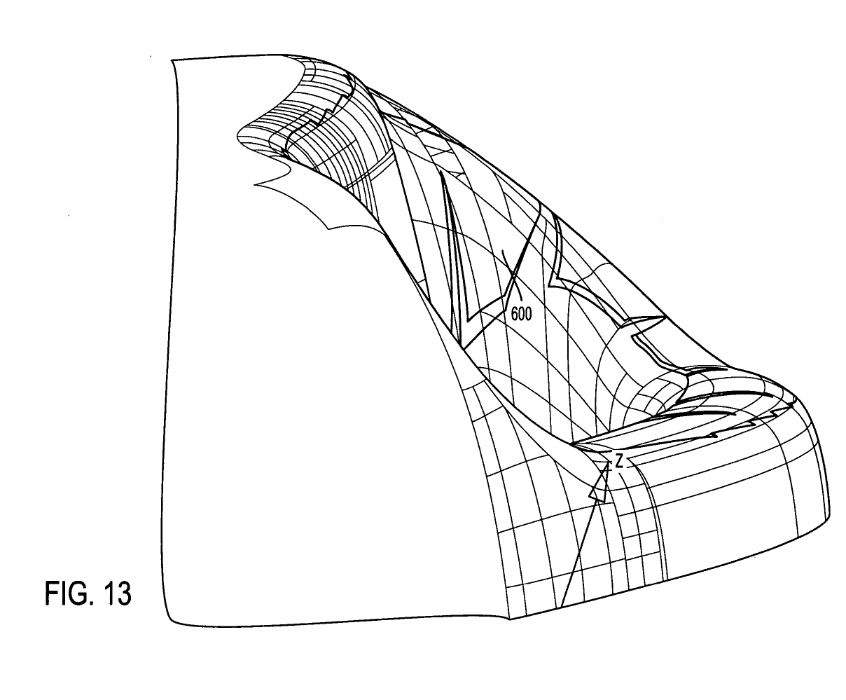

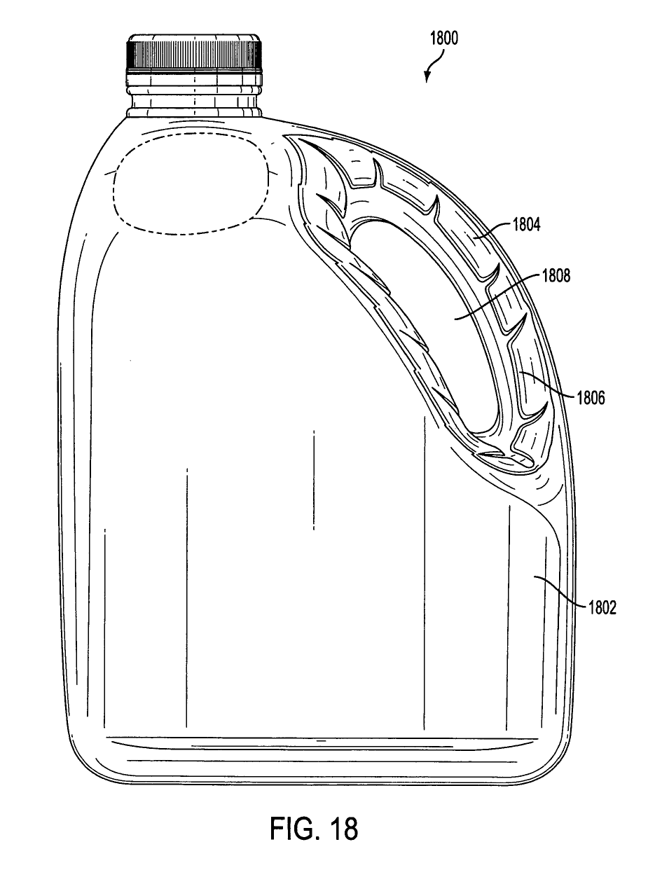

As illustrated in FIGS. 10-14, after projecting sculptural relief image 600 onto simulated container surface 1002 (step 404), a method according to the present invention may include manipulation (step 406), including but not limited to resizing and repositioning relief image 600, relative to container surface 1002. FIG. 10, for instance, shows an exemplary sculptured relief image 600 which has not yet been manipulated to approximately fit the container. FIG. 11 illustrates the exemplary relief after some resizing. FIGS. 12 to 13 are representations of an exemplary relief which has been resized and rotated enough to almost fit the container, and is being selectively stretched and resized to wrap around the various contours of handle 212 and sidewall 202 of container 200. For example, in progressing from the exemplary structure shown in FIG. 12 to the exemplary structure shown in FIG. 13, the relief image 600 is selectively extended to wrap into a position corresponding to the contour of the container wall underlying the handle 216. As will be discussed below, FIG. 18 shows an exemplary relief which has been fully manipulated to fit the container as designed according to an exemplary embodiment of the present invention.

After the sculptural relief is projected onto the simulated container surface (step 404), and suitably manipulated, the sculptural relief is preferably triangulated (step 408) to differentiate the surface of the sculptural relief projected onto the simulated container from the simulated container surface, which does not contain the projected surface of the sculptural relief. In effect, a digital data set is formed defining points of the sculptural relief relative to points defining the surrounding simulated container surface. Triangulation of shapes or images is a well known process, which involves using a plurality of triangles in a coordinate system to define a shape or image. Any other method for ascertaining the surface of the sculptural relief on the simulated mold cavity can be used.

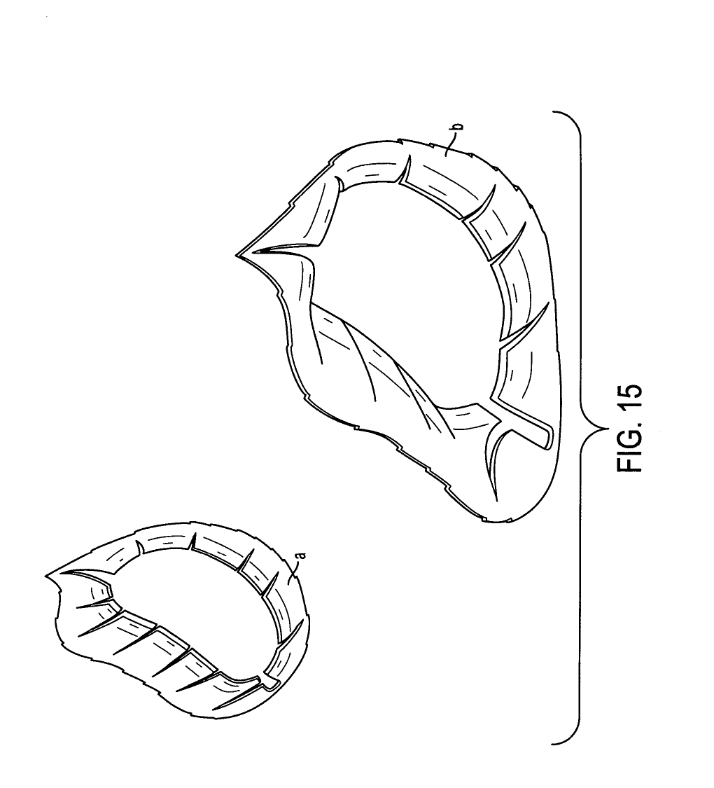

After the surface of the projected sculptural relief on the simulated container is ascertained, the simulated mold cavity surface outside boundary of the projected sculptural relief image are trimmed away or removed (step 410). FIGS. 15-17 illustrate an exemplary leaf texture relief image, comparing an exemplary flat relief (a) to an exemplary projected relief (b). The outer boundary of projected sculptural relief image shown in FIGS. 15-17 determines the profile or outline of the projected sculptural relief image (step 410). Steps 404 through 410 may be performed by commercially available software packages such as CopyCad® by Delcam®. Although these commercial software packages have been previously used to create images for preparing molds having a relief on an open surface of a container, their use in forming images on less open and more intricate surfaces was neither contemplated nor intended. The present invention thus represents a new use that lies outside the original limits of the software.

The profile (step 410) may provide one or more digital files to a tooling shop in a digital format familiar to the shop such as, for example, IGES or STL files. The digital images created according to the present invention are transformed into images for creating a mold. The tooling shop can then use these files to tool the desired image into the mold. Thus, in contrast to prior art method that impress a design into an existing mold, the present invention uses the combination of design software and tooling software to directly tool a pattern into a mold. Using this combination in this way allows a designer to incorporate features not contemplated nor attainable using prior art methods.

After the tooling shop has made the mold from an image generated through a method according to the present invention, the mold can be used to make a container having the relief image thereon. The container may be made of a plastic material, such as nylon; polyolefins, such as polypropylene, high density polyethylene and low density polyethylene; and polyesters, such as polyethylene terephthalate, for example. The container may be made according to methods known to those skilled in the art such as injection blow-molding, stretch blow-molding, or extrusion blow-molding, for example.

FIG. 18 shows a container 1800 comprising sidewall 1802 and handle 1804 having a three-dimensional sculptured image 1806 applied thereon according to an exemplary embodiment of the present invention. According to an exemplary embodiment of the present invention, handle 1804 creates a hole 1808 between itself and sidewall 1802. Because of hole 1808, image 1806 must be applied at an oblique angle in order to be applied to sidewall 1802 and handle 1804 simultaneously.

While the invention has been described in detail with reference to specific and preferred embodiments, it will be appreciated that various modifications and variations will be apparent to the artisan. All such modifications and embodiments as may occur to one skilled in the art are intended to be within the scope of the appended claims.

What is claimed is:

1. A method in a computer system for generating an image for producing a design for a container, the method comprising the steps of:
generating a virtual sculptural relief design;
projecting the virtual sculptural relief onto a virtual container surface, said virtual container surface corresponding to a non-open region of said container;
manipulating said relief in three-dimensional space to provide a virtual projected sculptural relief on said non-open region of said virtual container surface; and
removing the virtual conatiner surface outside the profile of the virtual projected sculptural relief.

2. The method according to claim 1, further comprising the step of converting the virtual relief into a numerical control language.

3. The method according to claim 1, wherein the step of removing the virtual container surface includes triangulating the virtual projected sculptural relief.

4. The method of claim 3, further comprising the step of displaying a combined triangulated virtual projected sculptural relief and virtual container, which together form an image of a finished container.

5. The method of claim 1, wherein said non-open region comprises a handle region.

6. The method of claim 5, wherein said handle region comprises a handle and an interior handle surface.

7. The method of claim 1, wherein the manipulating step comprises at least one of rotating at least a portion of said virtual relief, extending at least a portion of said virtual relief, contracting at least a portion of said virtual relief, and bending at least a portion of said virtual relief.

8. The method of claim 1, further comprising the step of generating a two-dimensional shape prior to the step of generating the sculptural relief, wherein the sculptural relief is generated from the two-dimensional shape.

9. The method of claim 1, further comprising the step of transferring the design to a machine code suitable for making a mold.

10. A method of making a mold part for a container comprising the steps of:
designing an image for a container including the steps of:
generating a virtual sculptural relief design;
projecting the virtual sculptural relief onto a virtual container surface, said virtual container surface corresponding to a non-open region of said container;
manipulating said relief in three-dimensional space to provide a virtual projected sculptural relief on said non-open region of said virtual container surface; and
removing the virtual conatiner surface outside the profile of the virtual projected sculptural relief, and
tooling a mold for a container having the design.

11. The method of claim 10, further comprising the step of finishing said mold by hand tooling.

12. The method of claim 10, further comprising the step of converting the virtual relief into a numerical control language.

13. The method of claim 12, wherein the numerical control language is a computer file format usable by a tooling shop.

14. The method according to claim 12, further comprising the step of using the numerical control language to machine tool a mold having the sculptural relief designed therein.

15. A computer system for generating an image for producing a design for a container, the computer system comprising:
input means for providing a virtual sculptural relief;
projecting means for projecting the virtual sculptural relief onto a virtual container surface, said virtual container surface corresponding to a non-open region of said container;
manipulating means for manipulating said relief in three-dimensional space to provide a virtual projected sculptural relief on said non-open region of said virtual container surface; and
removing means for removing the virtual container surface outside the profile of the virtual projected sculptural relief.

16. The computer system according to claim 15, further comprising displaying means for displaying the combined virtual projected sculptural relief and virtual container.

17. The computer system according to claim 15, further comprising converting means for converting the virtual relief into a numerical control language.

18. The computer system according to claim 17, wherein the numerical control language is a computer file format usable by a tooling shop.

19. The computer system according to claim 17 further comprising inputting numerical data from said converting means into tooling software for making a mold.

20. An computer system for generating an image for producing a design for a container, the computer system comprising:
input means for providing a virtual sculptural relief,
projecting means for projecting the virtual sculptural relief onto a virtual container surface, said virtual container surface corresponding to a non-open region of said container;
displaying means for displaying the virtual sculptural relief and virtual container;
manipulating means for manipulating said relief in three-dimensional space to provide a virtual projected sculptural relief on said non-open region of said virtual container surface; and
removing means for removing the virtual container surface outside the profile of the virtual projected sculptural relief; and
converting means for converting at least one of the virtual sculptural relief and the virtual projected sculptural relief into a numerical control language.

21. A method of making a container with a relief design thereon, the method including the steps of:
designing an image for a container including the steps of:
generating a virtual sculptural relief design;
projecting the virtual sculptural relief onto a virtual container surface, said virtual container surface corresponding to a non-open region of said container;
manipulating said relief in three-dimensional space to provide a virtual projected sculptural relief on said non-open region of said virtual container surface; and
removing the virtual conatiner surface outside the profile of the virtual projected sculptural relief;
tooling a mold for a container having the design; and
molding the container in said mold from a material.

22. The method of claim 21, wherein said molding step comprises at least one of injection blow-molding, stretch blow-molding, and extrusion blow-molding.

23. The method of claim 21, wherein said material is a plastic.

24. The method of claim 23 wherein the plastic is polyethylene terephthalate.

25. The method of claim 23, wherein the plastic is selected from nylon; polyolefins; and polyesters.

25. The method of claim 25, wherein the polyolefins are selected from polypropylene, high density polyethylene and low density polyethylene.

26. A container having a relief thereon, said relief designed by the method of claim 1.

27. A container having a relief thereon, said container made from a mold prepared according to the method of claim 10.

28. A container having a relief thereon, said container made by the method of claim 21.
